(19) United States
(12) Patent Application Publication
(10) Pub. No.: US 2026/0148477 A1
(43) Pub. Date: May 28, 2026

(54) THREE-DIMENSIONAL RECONSTRUCTION FROM A SINGLE-VIEW IMAGE

(71) Applicant: Adobe Inc., San Jose, CA (US)

(72) Inventors: Jimei Yang, Mountain View, CA (US); Zhenzhen Weng, Palo Alto, CA (US); Zhan Xu, San Jose, CA (US); Yang Zhou, Mountain View, CA (US); Jingyuan Liu, Santa Clara, CA (US); Hao Tan, San Jose, CA (US)

(21) Appl. No.: 18/959,431

(22) Filed: Nov. 25, 2024

(51) Int. Cl. G06T 15/08; G06T 15/20; G06V 10/82

(52) U.S. Cl. CPC G06T 15/08; G06T 15/205; G06V 10/82

(57) ABSTRACT

In some embodiments, a computing system receives an input image of a target in a first view. The computing system creates a single-view feature representation of the target using a trained single-view reconstruction model based on the input image. The computing system generates a multi-view feature representation of the target using a pre-trained generative model based on the single-view feature representation. The computing system determines a 3-dimensional (3D) representation of the target based on the multi-view feature representation using a neural volume rendering algorithm. The computing system generates one or more output images of the target in one or more views based on the 3D representation of the target.

### FIELD OF THE INVENTION

This disclosure relates generally to generative artificial intelligence. More specifically, but not by way of limitation, this disclosure relates to 3-dimensional (3D) reconstruction from a single-view image.

### BACKGROUND OF THE INVENTION

Three-dimensional (3D) model reconstruction is a computer vision technique for creating a 3D model based on one or more two-dimensional (2D) images. 3D model reconstruction is widely used in image processing, video games, virtual reality, augmented reality, and many other applications involving 3D models of humans.

Parametric reconstruction methods focus on pose and shape parameters of Skinned Multi-Person Linear (SMPL) human body mesh templates, which do not include clothing details. Human body mesh templates are pre-made 3D models of the human body including detailed mesh structures that can be manipulated and customized to create different body shapes, poses, or other features. Due to their lack of clothing details, parametric reconstruction methods have limited utility in applications requiring realistic and detailed human representations. Implicit volume reconstruction methods capture fine-grained clothing details with pixel-aligned features, but do not generalize across various poses. Hybrid approaches combine the advantages of parametric and implicit volume reconstruction methods by using predicted SMPL body mesh templates as conditioning to guide reconstruction of a fully clothed model. Conditioning is the process of adding information to an algorithm, such as a machine learning model, to make it more useful for specific applications. However, a significant limitation of such hybrid methods is that SMPL prediction errors necessarily propagate to the subsequent full reconstruction stage, which tends to result in misalignment between the reconstructed mesh and the input image with regard to the pose and shape of the person.

Some 3D model reconstruction methods used Neural Radiance Fields (NeRFs) to learn both the geometry and texture of the human subject. These methods typically use single images to fine-tune pre-trained reconstruction models, which is time consuming and not generalizable to new observations. Feed-forward NeRF prediction models such as Large Reconstruction Models (LRMs) are more generalizable and produce high-quality 3D model reconstructions as well as NeRFs from arbitrary image inputs. However, directly applying pre-trained generic LRM to images of humans tends to produce reconstructed surfaces that are too coarse. In other words, the reconstructed surfaces do not preserve sufficient geometric and textural details even when the pre-trained generic LRM is fine-tuned.

### BRIEF SUMMARY OF THE INVENTION

Certain embodiments involve reconstructing 3D models of a target, such as a human, from a single-view image. For example, pose, shape, and surface texture of the target are reconstructed in 3D by using an input image captured from a single viewpoint. The 3D reconstruction methods described herein are particularly well-suited for images of humans, but can be used for images of characters, animals, and other subjects as well. In one example, a computing system receives an input image from an image source, for example, from a data store or from a client device. The input image shows a target from a particular viewpoint. A part of the target may be occluded in the single-view input image. The computing system determines a single-view feature representation using a single-view reconstruction model. The computing system generates a multi-view feature representation using a trained generative model with the single-view feature representation as conditioning. The computing system determines a 3D model of the target based on the multi-view feature representation using a neural volume rendering algorithm. The computing system generates one or more output images of the target from one or more viewpoints based on the 3D model of the target. The output images may be stored or sent to the client device. The one or more output images are provided to the client device for display or use in various applications, for example animation, games, virtual reality, and augmented reality.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, embodiments, and advantages of the present disclosure are better understood when the following Detailed Description is read with reference to the accompanying drawings.

FIG. 1 depicts an example of a computing environment in which a 3D model reconstruction system provides one or more output images from different viewpoints for a target based on an input image of the target from one viewpoint, according to certain embodiments of the present disclosure.

FIG. 2 depicts an example of a process for generating one or more output images of a target from different viewpoints, according to certain embodiments of the present disclosure.

FIG. 3 depicts an example of a process for training the 3D model reconstruction system in FIG. 1, according to certain embodiments of the present disclosure.

FIG. 4 depicts an example of a process for generating output images of a target from different viewpoints using the 3D model reconstruction system trained as described in FIG. 3, according to certain embodiments of the present disclosure.

FIG. 5 depicts an example of a comparison of reconstructed geometries by 3D model reconstruction methods described herein and various baseline methods, according to certain embodiments of the present disclosure.

FIG. 6 depicts an example of a comparison of rendered images in novel views using 3D model reconstruction methods described herein and various baseline 3D model reconstruction methods, according to certain embodiments of the present disclosure.

FIG. 7 depicts an example of a comparison of rendered images using 3D model reconstruction methods described herein and various baseline 3D model reconstruction methods based on input images with occlusions, according to certain embodiments of the present disclosure.

FIG. 8 depicts an example of the computing system for implementing certain embodiments of the present disclosure.

### DETAILED DESCRIPTION OF THE INVENTION

Certain embodiments provide a pre-trained multi-view generative model to reconstruct novel views from a single-view image of a target. The multi-view generative model does not rely on human mesh templates and is trained to predict multi-view features from single-view features extracted from a single-view image. A neural volume rendering algorithm is used to predict SDF values for volume rendering instead of density, which leads to enhanced surface fidelity for the final 3D model reconstruction. Additionally, normal and depth maps are used for human geometry reconstruction to provide higher-quality surface reconstruction. A “single-view image” is a 2D image that shows the target, or a scene including the target, from one camera viewpoint. The computing system generates a single-view feature representation of the target by using a single-view reconstruction model. The “single-view feature representation” is a feature representation or a triplane with feature tokens extracted from the input image and projected to three axis-aligned planes. Feature tokens are datasets representing different visual features of an image, such as color, shape, and texture. The “single-view reconstruction model” is a reconstruction model that can extract or predict the feature tokens from the input image taken from the specific camera viewpoint.

The computing system then generates a multi-view feature representation of the target based on the single-view feature representation, using a trained generative model, for example a diffusion model (e.g., a U-Net). The multi-view feature representation is a feature representation or a triplane with predicted features of the target as seen from multiple different viewpoints. The computing system determines a 3D model of the target based on the multi-view feature representation using a multi-view reconstruction model that can extract or predict feature tokens in multiple camera views from a 2D input image. In some embodiments, the multi-view reconstruction model is a neural volume rendering algorithm. The 3D model includes values representing the geometry and appearance (e.g., texture and color) of the target. The computing system generates one or more output images of the target from different viewpoints based on the 3D model of the target. Compared to conventional methods, such as the parametric reconstruction and hybrid parametric/implicit volume reconstruction methods mentioned previously, the 3D model reconstruction techniques described herein do not rely on human body mesh templates, allowing for effective generalization in complex situations. In addition, the 3D model reconstruction techniques described herein predict a neural volume rendering algorithm for rendering a 3D model of the target with signed distance functions (SDFs) instead of generalized density function. Using a random level set of a generalized density function to extract a 3D geometry often causes noise and inaccurate shapes or dimensions in the 3D geometry. In contrast, an SDF measures a distance between a point and a boundary of a shape. The present 3D model reconstruction techniques use SDF values to reconstruct the 3D geometry, which improves the surface fidelity of the 3D model.

The following non-limiting example is provided to introduce certain embodiments. In this example, a 3D model reconstruction system communicates with a client device over a network. The client device sends a single-view input image of a target to the 3D model reconstruction system. One portion of the target (e.g., part of an arm, part of a leg, part of the torso) is occluded within the single-view input image. The target can be any type of object in the single-view input image, such as a person, an animal, or any other 3D object, whether real, illustrated, animated, simulated, or shown in any other form. The 3D model reconstruction methods described herein are particularly well suited for use cases where the target is a human and, thus, this introductory example and other exemplary embodiments described herein are directed to such use cases. It will be appreciated that the invention is not limited to such use cases, however.

In some examples, the 3D model reconstruction system creates a single-view feature representation of the person by using a trained single-view reconstruction model based on the single-view input image of the person. The trained single-view reconstruction model includes an image encoder (e.g., a pre-trained vision transformer model) for extracting a set of patch-wise feature tokens from the single-view input image. The trained single-view reconstruction model also includes an image decoder to decode the set of patch-wise feature tokens to a triplane to create the single-view feature representation. The triplane includes three axis-aligned feature planes representing point features of the person in the input image.

The 3D model reconstruction system generates a multi-view representation of the person using a pre-trained 3D diffusion model (e.g., a U-Net) based on the single-view feature representation. The pre-trained 3D diffusion model predicts features of the occluded portion of the person in the input image to be included in the multi-view feature representation.

The 3D model reconstruction system determines a 3D model of the person based on the multi-view feature representation using a neural volume rendering algorithm. The 3D model of the person includes the geometry (e.g., shape and pose) and the appearance (e.g., clothes and color). The neural volume rendering algorithm includes a first multilayer perceptron (MLP) module for determining SDF values and a second MLP module for determining color values. SDF values and color values can be used to determine the 3D model of the person. The occluded portion in the input image can also be reconstructed and included in the 3D model of the person.

The 3D model reconstruction system provides one or more output images of the person in different views to a client device, which can display the one or more output images via a graphical user interface (GUI). The one or more output images can be used in asset creation, image processing, animation, games, augmented reality, virtual reality, or any other suitable areas. For example, an input image includes a person pitching a baseball in the front view. The input image can be processed to generate output images of the person pitching a baseball in different views (e.g., side view, back view, etc.). If a portion of the person's torso is occluded in the input image, that portion can be recreated and shown in the output images.

Certain embodiments of the present disclosure overcome the disadvantages of the prior art by using a single-stage feed-forward large reconstruction model that predicts the geometry and appearance of a target from a single image. Unlike existing generalizable human reconstruction models that use a predicted template mesh to transform image features to the canonical space, the 3D model reconstruction techniques disclosed herein are template-free, allowing for effective generalization in complex situations where template-conditioned methods are inadequate. For example, errors from predicting pose or shape parameters by template-conditioned methods cause misalignment between the reconstructed human body meshes and input images with respect to the pose or shape of the target. The present methods do not rely on a human mesh template and, thus, do not suffer from this problem. Embodiments of the present disclosure use a neural volume rendering algorithm to predict SDF values for volume rendering instead of density, which leads to enhanced surface fidelity for the final 3D model reconstruction. Additionally, normal and depth maps are used for human geometry reconstruction to provide higher-quality surface reconstruction. For example, ground truth normal maps and depth maps from the input image are used to supervise rendering the human geometry with predicted normals and depths. Such supervision provides better surface details in the rending of the human geometry. The generative model is trained to distill multi-view reconstruction from a single-view image through conditional triplane diffusion, providing generative capabilities to output full body humans from partial observations.

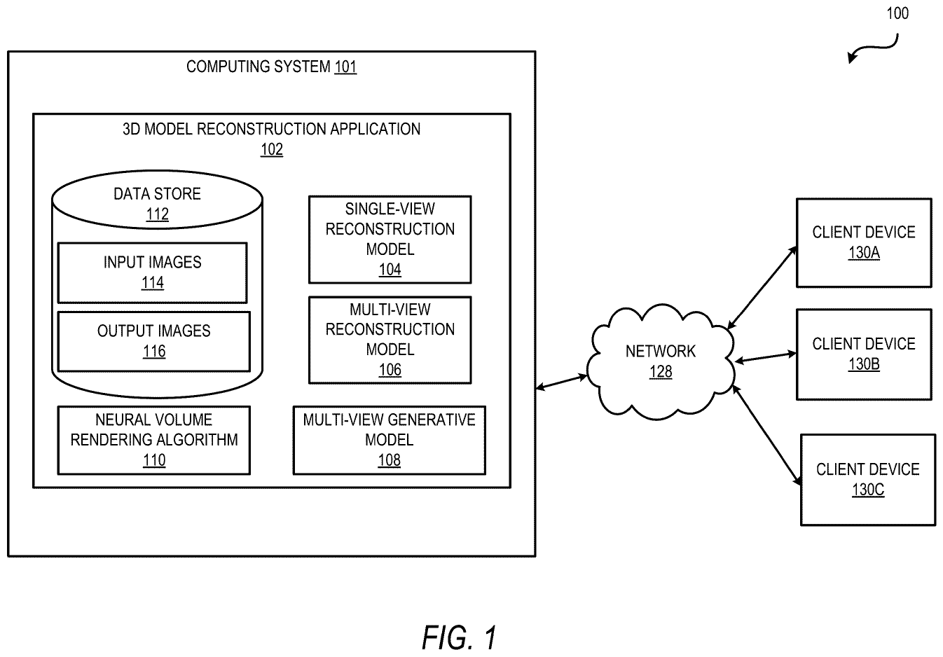

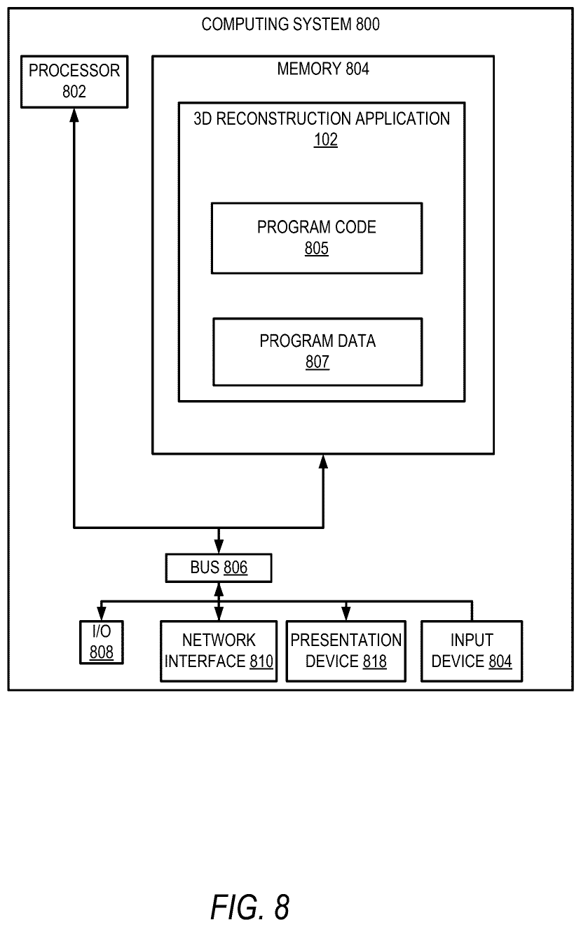

Referring now to the drawings, FIG. 1 depicts an example of a computing environment 100 in which a 3D model reconstruction application 102 provides one or more output images from different viewpoints of a target based on an input image of the target from one viewpoint, according to certain embodiments of the present disclosure. In various embodiments, the computing environment 100 includes a computing system 101 in communication with client devices 130A, 130B, and 130C (which may be referred to herein individually as a client device 130 or collectively as the client devices 130) via a network 128. The network 128 may be a local-area network (“LAN”), a wide-area network (“WAN”), the Internet, or any other networking topology known in the art that connects the client device 130 to the 3D model reconstruction application 102. The computing system 101 can be a server or any other suitable computing device. In some examples, the computing system 101 is the computing system 800 as will be described in FIG. 8. The computing system 101 executes the 3D model reconstruction application 102. The client device 130 may be a desktop computer, a laptop computer, a mobile computing device or any other suitable computing device.

The client device 130 is configured to transmit a request to the 3D model reconstruction application 102 for generating one or more output images 116 in different views based on a single-view input image 114 of a target. The request from the client device 130 can include the single-view input image 114 of the target or can include a selection of a single-view input image 114 stored in the data store 112 of the 3D model reconstruction application 102 or any other location accessible by the 3D model reconstruction application 102. The single-view input image 114 of the target is captured by a camera from one viewpoint. The camera may be part of or separate from the client device 130. In some cases, the single-view input image 114 target is pre-captured and saved on the client device 130 or some other network accessible location. In other cases, the single-view input image 114 is captured in real time by a camera integrated into the client device 130.

The 3D model reconstruction application 102 includes a single-view reconstruction model 104 configured to generate a single-view feature representation of the target in the single-view input image 114. The single-view reconstruction model 104 includes an encoder module, for example a pre-trained vision transformer model, configured to encode the single-view input image 114 to patch-wise feature tokens. The single-view reconstruction model 104 also includes a decoder module configured to decode the image tokens into a triplane. In some examples, the decoder module implements a transformer model. The transformer model updates the patch-wise feature tokens to triplane features via camera modulation and cross-attention with the feature tokens. Each transformer layer of the transformer model can include a cross-attention sub-layer, a self-attention sub-layer, and an MLP sub-layer. Each feature token can be modulated by camera features at each sub-layer. The cross-attention layer can attend from the triplane features to the image tokens, which can help link image information to the triplane. The self-attention layer can further model the intra-modal relationships across the spatially structured triplane entries.

The triplane with single-view features, also referred to as a single-view feature triplane, is a single-view feature representation of the target in the single-view input image 114. The triplane contains three axis-aligned feature planes. Each plane has a spatial resolution and a number of feature channels. A 3D point of the target is projected onto each plane to query the corresponding point features, for example via bilinear interpolation, which is decoded for rendering by neural volume rendering algorithm 110 as described below. In some embodiments, the single-view feature triplane is perturbed with noise data, for example Gaussian noise, to become a noised single-view feature triplane. The noised single-view feature triplane is then used for predicting multi-view feature representation of the target, for example 3D multi-view triplane.

The 3D model reconstruction application 102 includes a multi-view generative model 108 configured to generate a multi-view feature representation of the target. In some embodiments, the multi-view generative model is a 3D diffusion model, for example a U-Net. The 3D diffusion model is trained to predict a multi-view triplane based on the single-view triplane perturbed with noise data.

The 3D model reconstruction application 102 includes a multi-view reconstruction model 106 used for training the multi-view generative model. In some examples, the multi-view reconstruction model 106 is not part of the 3D model reconstruction application 102 but is, instead, a separate model in the computing system 101. The multi-view reconstruction model 106 includes an image encoder and an image decoder. A set of multi-view training images can be provided as training input to train the multi-view reconstruction model 106. In some examples, the set of multi-view training images include subsets of four images from four viewpoints of corresponding targets. The multi-view reconstruction model 106 is trained to predict a multi-view feature representation (e.g., multi-view feature triplane). After the multi-view reconstruction model 106 is trained, the weights in the multi-view reconstruction model 106 are frozen before training the single-view reconstruction model 104.

A single-view image from the set of multi-view training images can be used as training input to the single-view reconstruction model 104. In some examples, a random mask can be applied to the single-view image to block a part of the target. The single-view reconstruction model 104 can be trained to predict a single-view feature representation (e.g., single-view feature triplane), including recreating the occluded part of the target.

In some embodiments, the multi-view feature triplane created by the multi-view reconstruction model 106 is perturbed with multiple steps of Gaussian noise, to become a noised multi-view feature triplane. The noised multi-view feature triplane is used as training input to train the multi-view generative model 108 to denoise and restore the multi-view feature triplane. The single-view feature triplane, predicted by the single-view reconstruction model 104, is provided as conditioning for training the multi-view generative model 108. In some embodiments, the multi-view feature triplane and the single-view feature triplane are flattened before being used for training the multi-view generative model 108.

The 3D model reconstruction application 102 includes a neural volume rendering algorithm 110 for generating a 3D model, also referred to as a 3D representation, of the target based on the multi-view feature representation generated by the multi-view generative model 108. In some embodiments, the neural volume rendering algorithm 110 includes a first MLP model configured to predict SDF values from point features queried from the multi-view feature triplane generated by the multi-view generative model 108. For example, the first MLP takes the point features corresponding to certain sampled points as input and generate SDF values and a latent vector as output. The SDF values are used to determine depth values related to sampled points, which are used for rendering a depth map for the target. The SDF values can also be used to compute normal values at sampled points using finite differences, which can be used for rendering a normal map for the target. In some embodiments, neural volume rendering algorithm 110 also includes a second MLP configured to predict color values, for example red-green-blue (RGB) values. For example, the second MLP takes the point features, latent vector, and normal values as input, and generates RGB values as output. The SDF values and the RGB values are used for rendering output images 116 in different views.

In some examples, a user selects one or more viewpoints for the output images 116. In some examples, the neural volume rendering algorithm 110 includes pre-defined viewpoints for output image rendering. The output images 116 in different views are generated based on the 3D representation of the target. The output images 116 can be stored in the data store 112 and/or provided to the requesting client device 130.

The data store 112 is configured to store data processed or generated by the 3D model reconstruction application 102. Examples of the data stored in data store 112 include the single-view input images 114 and output images 116 in multiple views related to a target in corresponding single-view images. Training data used for training the single-view reconstruction model 104, the multi-view reconstruction model 106, the multi-view generative model 108, and the neural volume rendering algorithm 110 can also be stored in the data store 112. In addition, data generated by the 3D model reconstruction application 102 during a reconstruction process, for example single-view feature triplanes, multi-view feature triplanes, SDF values, RGB values, can also be stored in the data store 112, temporarily or permanently. The network architecture shown in FIG. 1 is provided by way of example only. In other embodiments, the 3D model reconstruction application 102 could also or alternatively be executed locally on a client device 130 or on other device(s) not shown. The 3D model reconstruction application 102 can, in some embodiments, be a component of a larger software program, for example a graphics editing application.

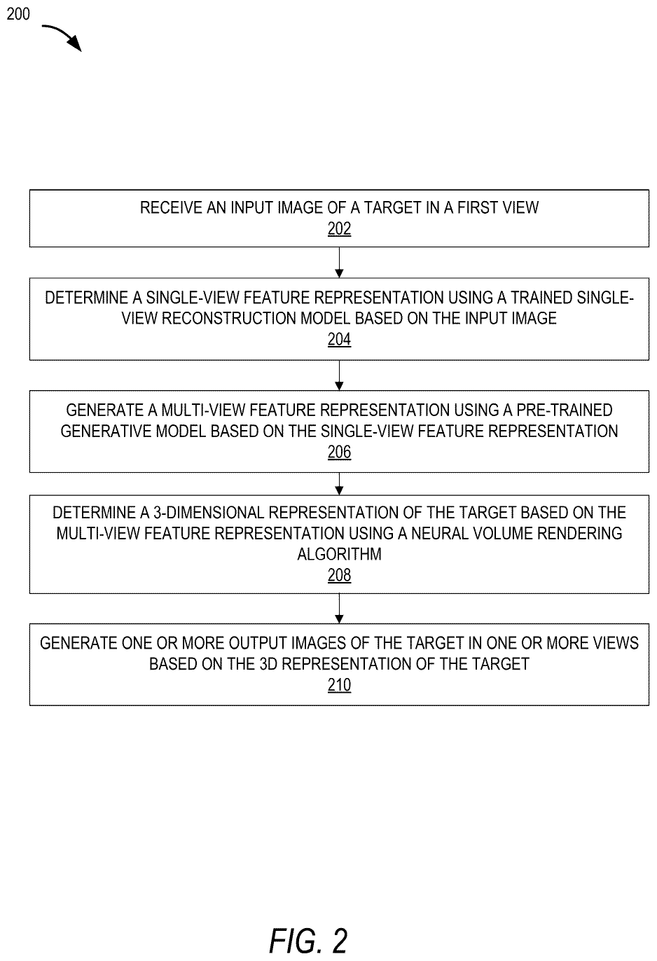

FIG. 2 depicts an example of a process 200 for generating one or more output images of a target from different viewpoints, according to certain embodiments of the present disclosure. At block 202, a computing system 101 receives an input image 114 of a target in a first view. The input image can be received from a client device 130 or from a local or remote data store. The input image 114 can be pre-captured by a camera or pre-created by a computer.

At block 204, the computing system 101 determines a single-view feature representation of the target using a trained single-view reconstruction model 104 based on the input image 114. The computing system 101 includes a 3D model reconstruction application 102, which includes a trained single-view reconstruction model 104. The trained single-view reconstruction model 104 includes an image encoder and an image decoder. In some examples, the image encoder is a vision transformer model. The vision transformer model encodes the input image 114 to patch-wise feature tokens. For example, the patch-wise feature tokens are denoted as

$${\{ {h}_{i} \}}_{i = 1}^{n} ∈ {ℝ}^{768} ,$$

where i denotes the i-th image patch, n is the total number of patches, and 768 is the latent dimension. In some embodiments, the image decoder is a transformer model. The transformer model modulates the patch-wise feature tokens with camera features and update the feature tokens to triplane features to create a single-view feature triplane. The single-view feature triplane is a single-view feature representation of the target in the single-view input image 114. A triplane T contains three axis-aligned feature planes T_{XY}, T_{YZ} and T_{XZ}. Each feature plane is of dimension h_{T}× [symbol] _{T}×d_{T}, where h_{T}× [symbol] _{T} is the spatial resolution, and d_{T} is the number of feature channels. Any 3D point in an object bounding box [−1,1]³ can be projected onto each of the planes, and corresponding point features T_{xy}, T_{yz}, and T_{xz} can be obtained via bilinear interpolation. The point features T_{xy}, T_{yz}, and T_{xz} are then decoded for rendering. In some embodiments, functions included in block 204 are used to implement a step for determining a single-view feature representation of the target using a trained single-view reconstruction model based on the input image.

At block 206, the computing system 101 generates a multi-view feature representation of the target using a pre-trained multi-view generative model 108 based on the single-view feature representation. The single-view feature representation may have two limitations: (1) collapsed reconstruction on the unseen parts and (2) incapability of handling occlusions. The 3D model reconstruction application 102 in the computing system 101 includes a pre-trained multi-view generative model 108. The pre-trained multi-view generative model 108 is used to generate a multi-view feature representation by predicting features in novel views and in an occluded part of the input image.

A multi-view reconstruction model 106 in the computing system 101 is used to train the multi-view generative model 108. The multi-view reconstruction model 106 is similar to the single-view reconstruction model 104 used at block 204, except that the multi-view reconstruction model 106 may not take camera conditioning. The multi-view reconstruction model 106 is trained with a set of training images in different views of one or more targets to generate multi-view feature triplanes. With a sufficient number of views, a learned triplane can be conceptualized as a near-perfect representation of the target. For example, four images in four different views of a target can be a subset of training images corresponding to one target. The set of training images includes, for example, multiple subsets of four-view images corresponding to multiple targets to train the multi-view reconstruction model 106 for generating multi-view feature triplanes for corresponding targets.

In some embodiments, after the multi-view reconstruction model 106 is trained, it is frozen. That is, the parameters or weights in the trained multi-view reconstruction model are prevented from being modified. The single-view reconstruction model is then being trained with a set of training images in single views of one or more targets to generate single-view triplanes. In some examples, a random mask (e.g., a binary mask) is applied to each of the set of training images in single views to create an occlusion in each image.

The trained multi-view reconstruction model 106 generates a multi-view feature triplane based on a set of images in different views (e.g., 4 views) of a target. Gaussian noises can optionally be added to the multi-view feature triplane to obtain a noised multi-view feature triplane. Meanwhile, the trained single-view reconstruction model 104 generates a single-view feature triplane based on a single-view image from the set of images indifferent views. To train the 3D diffusion model, the single-view triplane generated by the single-view reconstruction model 104 is used as conditioning and concatenated with the noised multi-view feature triplane to form the training inputs to the multi-view generative model 108. The corresponding multi-view feature triplane is the training output. In some embodiments, the 3D diffusion model is trained to denoise the noised multi-view triplanes to generate the corresponding multi-view feature triplane. If occlusions exist in the single-view image, the multi-view generative model is also trained to predict features in the occluded portion of the target.

At block 208, the computing system 101 determines a 3D representation of the target based on the multi-view feature representation using a neural volume rendering algorithm 110. The 3D model reconstruction application in the computing system 101 includes a neural volume rendering algorithm 110. In some examples, the neural volume rendering algorithm 110 is a neural radiance field (NeRF) algorithm. The neural volume rendering algorithm 110 includes a first MLP for predicting SDF values and a latent vector from point features queried from the multi-view feature triplane generated at block 206. The SDF values can be used to determine depth values and normal values. The neural volume rendering algorithm 110 also includes a second MLP for predicting color values at sampled points based on the point features, latent vector, and normal values at sample points computed from the SDF values. The depth values and normal values are used to render a depth map and normal map respectively. The color values are used to render an RGB map. The depth map, normal map, and the RGB map describe different aspects of the target at corresponding 3D points. The 3D representation of the target includes geometry and appearance. The geometry is described by the depth map and the normal map. The appearance of the target includes texture and color, which are described by the normal map and the RGB map respectively. In some embodiments, functions included in block 208 are used to implement a step for determining a 3D representation of the target based on the multi-view feature representation using a neural volume rendering algorithm.

At block 210, the computing system 101 generates one or more output images 116 of the target in one or more views based on the 3D representation of the target. The output images can be stored in a data store and/or provided to a client device 130. In some examples, a user of the 3D model reconstruction application 102 or the client device 130 is provided with means, such as a user interface, to select the one or more views for the output images 116. In some examples, the 3D model reconstruction application 102 automatically renders output images 116 in pre-determined views. In some examples, a portion of the target is occluded or blocked in the input image 114 in the first view. The output images 116 display the portion that was occluded in the input image 114. Alternatively, or additionally, the 3D model reconstruction application 102 can be configured to generate a detailed 3D mesh, which can be used in various applications, for example image relighting or other suitable types of image processing.

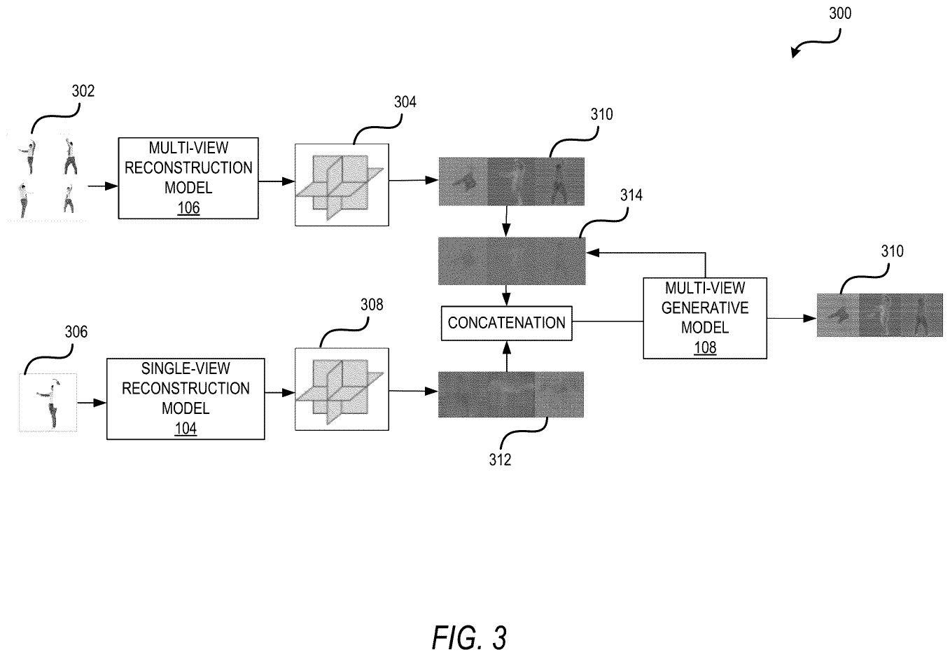

FIG. 3 depicts an example of a process 300 for training the 3D model reconstruction application 102 described with respect to FIG. 1, according to certain embodiments of the present disclosure. A set of multi-view training images 302 is provided to the multi-view reconstruction model 106, with corresponding camera parameters. In the illustrated example, the target in each of the multi-view training images 302 is a person. The set of multi-view training images 302 includes multiple training images taken from multiple views. With a sufficient number of viewpoints (e.g., 4) for the training target (i.e., the person), the multi-view reconstruction model 106 can conceptualize a multi-view feature triplane 304. Multiple sets of multi-view training images 302 corresponding to multiple training targets, i.e., multiple people, can be used for training the multi-view reconstruction model 106. Once the multi-view reconstruction model 106 is trained, the parameters or weights in the multi-view reconstruction model 106 are fixed, before the single-view reconstruction model 104 and the multi-view generative model 108 are trained.

A single-view training image 306 for a target, in this case a person, is provided to the single-view reconstruction model 104, with corresponding camera parameters. The single-view training images 306 can be selected from the set of training images 302 for the corresponding training target. The single-view reconstruction model 104 is trained to generate a single-view feature triplane 308. Multiple single-view training images 306 corresponding to multiple training targets can be used to train the single-view reconstruction model 104. In some examples, a mask is applied to a single-view training image 306 to simulate real-world occlusions. The mask guides the multi-view generative model 108 to hallucinate the masked (or occluded) part of the single-view training image 306.

In some embodiments, the multi-view feature triplane 304 and the single-view feature triplane 308 are flattened to generate a reshaped multi-view triplane 310 and a reshaped single-view triplane 312. The multi-view generative model 108 can optionally add multiple steps of Gaussian noise to perturb the reshaped multi-view triplane 310, to generate a noised multi-view triplane 314. The noised multi-view triplane 314 is concatenated with the reshaped single-view triplane 312 (as conditioning) and used to train the multi-view generative model 108. The multi-view generative model 108 is trained to denoise the noised multi-view triplane 314 and reproduce the reshaped multi-view triplane 310.

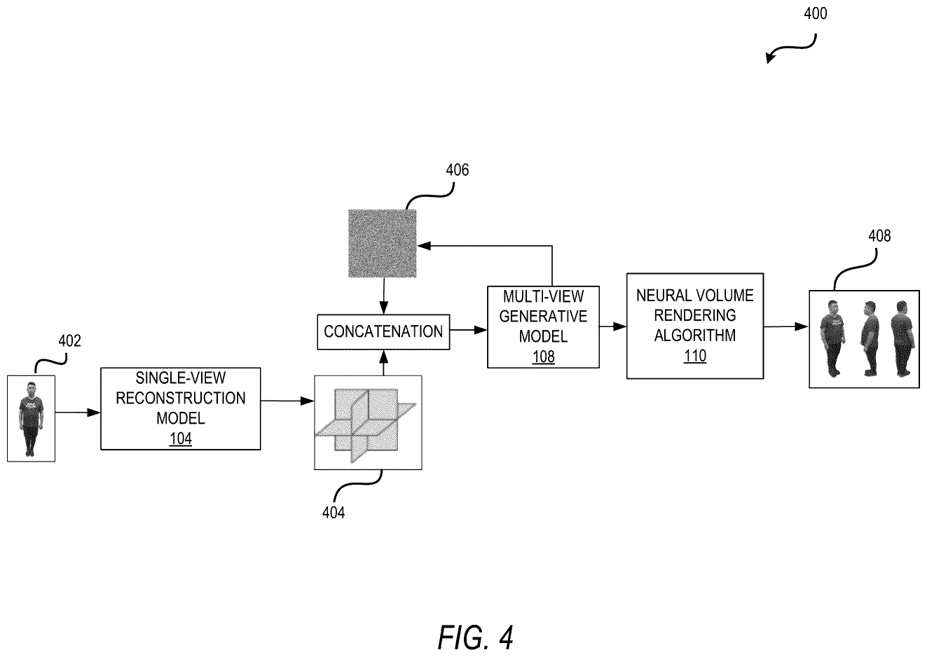

FIG. 4 depicts an example of a process 400 for generating output images of a target from different viewpoints using the 3D model reconstruction application 102 trained as described in FIG. 3, according to certain embodiments of the present disclosure. An input image 402 of a target in a single viewpoint is provided to the single-view reconstruction model 104 to generate a single-view feature triplane 404. Following the example of FIG. 3, the training target in the example of FIG. 4 is a person. The single-view feature triplane 404 is concatenated with multiple steps of Gaussian noise 406, which represent multi-view triplane noises. The multi-view generative model 108 predicts a multi-view feature triplane (not shown) based on the noised single-view feature triplane. The neural volume rendering algorithm 110 generates a 3D representation (not shown) of the person and provide output images 408 of the person based on the generated 3D representation.

Table 1 shows quantitative comparison of geometries reconstructed using various baseline reconstruction methods and the present 3D model reconstruction methods. For example, baseline method 1 uses a Pixel-aligned Implicit Function (PiFU) model, baseline method 2 uses an Implicit Clothed humans Obtained from Normals (ICON) model, and baseline method 3 uses Explicit Clothed humans Optimized via Normal integration (ECON) model. The models used in the baseline methods and the present 3D model reconstruction methods are trained using the same training dataset, for example 500 scans from database Thuman 2.0, to eliminate the influence of training data and ensure a fair comparison. The baseline methods and the present methods are evaluated using three different evaluation datasets. For example, evaluation dataset 1 includes 20 humans from database Thuman 2.0, with renderings from 18 evenly spaced viewpoints. Evaluation dataset 2 includes 20 humans from database Alloy++, with renderings from 18 evenly-spaced viewpoints. Evaluation dataset 3 includes 20 human subjects, with 460 frames of distinct poses. The quantitative result of the comparison is shown in Table 1 below. The metrics used for the comparison include Chamfer distance, Point-to-Surface (P2S), and Normal Consistency (NC). The lowest value for each metric indicates the best outcome. It can be seen from the comparison that the geometry generated by the present 3D model reconstruction methods are superior to the geometries generated by the baseline methods. Certain baseline methods, namely, baseline method 2 (ICON) and baseline method 3 (ECON), rely on the Skinned Multi-Person Linear (SMPL) human body mesh model to transform image features to canonical space. Ground truth SMPL body mesh templates limit their model representation power. In contrast, the present 3D model reconstruction methods do not rely on any template and, thus, do not suffer from problems caused by errors from predicted SMPL parameters.

TABLE 1
Quantitative comparison of geometries reconstructed using baseline reconstruction
methods and the present 3D model reconstruction method

| | Evaluation dataset 1 | | | Evaluation dataset 2 | | | Evaluation dataset 3 | | |
|---|---|---|---|---|---|---|---|---|---|
| Model | Chamfer ↓ | P2S ↓ | NC ↓ | Chamfer ↓ | P2S ↓ | NC ↓ | Chamfer ↓ | P2S ↓ | NC ↓ |
| Baseline 1 | 6.15 | 6.40 | 0.247 | 4.97 | 5.30 | 0.207 | 5.43 | 5.88 | 0.206 |
| Baseline 2 | 6.57 | 6.65 | 0.251 | 5.58 | 5.86 | 0.218 | 5.33 | 5.43 | 0.197 |
| Baseline 3 | 7.14 | 6.92 | 0.247 | 5.04 | 4.64 | 0.197 | 5.87 | 5.79 | 0.200 |
| Present | 2.62 | 2.60 | 0.124 | 3.22 | 2.99 | 0.145 | 2.43 | 2.25 | 0.106 |

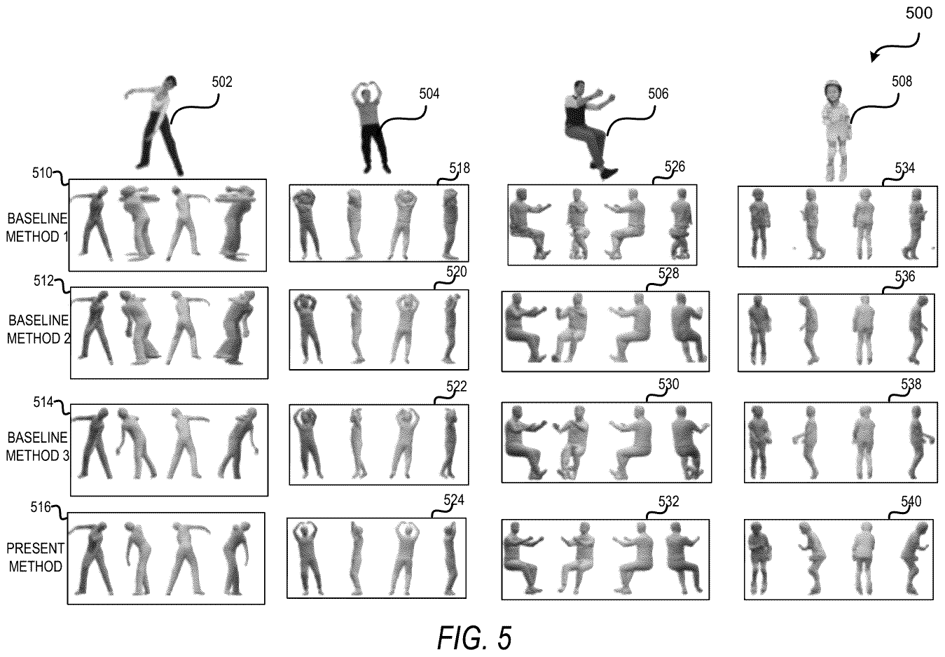

FIG. 5 depicts an example of a comparison 500 of reconstructed geometries generated by the 3D model reconstruction methods described herein and various baseline methods, according to certain embodiments of the present disclosure. In FIG. 5, four single-view input images 502, 504, 506, and 508 are provided to the models in the baseline methods and the present 3D model reconstruction methods separately. The geometries generated by the baseline methods and the present methods based on an input image are shown in four views respectively. For example, a set of output geometries 510 respectively generated by baseline method 1 based on input image 502 have more artifacts and hallucination than a set of output geometries 516 generated by a 3D model reconstruction method described herein. Similarly, a set of output geometries 512 generated by baseline method 2 have more artifacts and hallucination than the set of output geometries 516 generated by the 3D model reconstruction method described herein. A set of output geometries 514 generated by baseline method 3 based on input image 502 are better than the set of output geometries 510 and the set of output geometries 512. However, the second and third geometries of the set of output geometries 514 are distorted. There is not as much detail in the third output geometry (back view), as compared to that in the set of output geometries 516 generated by the 3D model reconstruction method described herein.

Similarly, with input image 504, four sets of output geometries (e.g., 518, 520, 522, or 524) are generated using three baseline methods and the 3D model reconstruction method described herein respectively. With input image 506, four sets of output geometries (e.g., 526, 528, 530, or 532) are generated using three baseline methods and the 3D model reconstruction method described herein respectively. With input image 508, four sets of output geometries (e.g., 534, 536, 538, or 540) are generated using three baseline methods and the 3D model reconstruction method described herein. It can be seen that the present 3D model reconstruction method provides exceptional generalizability to challenging cases such as people in rare poses, as shown in input image 502 and input image 504, as well as little children, as shown in input image 508.

Table 2 shows quantitative comparison of rendered images by different baseline methods and the present model reconstruction methods. Baseline method 4 uses a NeRF prediction model where an SMPL mesh is used to transform image features to canonical space. The ground truth (GT) SMPL parameters used in baseline method 4 are obtained through triangulation from multi-view captures. However, this process is impractical in real-world scenarios where only single-view capture is present. An alternative baseline method 4 uses estimated SMPL parameters, but the performance has a substantial decline when compared to baseline method 4 with GT SMPL parameters as shown in Table 2. This decline can be attributed to the fact that baseline method 4 involves pixel-aligned feature extraction which relies heavily on the assumption that the SMPL vertices align accurately with their corresponding pixel locations. In contrast, the present 3D model reconstruction methods do not rely on a pose prior, making it more resilient and adaptable for real-world scenarios. This robustness is demonstrated through improved quantitative results when compared to baseline method 4 with estimated SMPL parameters as shown in Table 2. The generated novel views can be compared using evaluation metrics, such as peak signal-to-noise ratio (PSNR), Structural Similarity Index Measure (SSIM), and Learned Perceptual Image Patch Similarity (LPIPS). PSNR is a ratio between the maximum power of a signal and the power of the noise that corrupts it. A higher PSNR value indicates a better reconstruction quality. SSIM measures the structural similarity between two images. A higher SSIM value indicates a better reconstruction quality. LPIPS measures the distances between image patches. A higher value indicates a lower reconstruction outcome. As can be seen in Table 2, the novel view images rendered using the present 3D model reconstruction methods have improved PSNR, SSIM, and LPIPS values as compared to the novel view images rendered using the baseline method 4 with estimated SMPL parameters.

TABLE 2
Quantitative comparison of rendered images by different methods

| Method | GT SMPL | PSNR ↑ | SSIM ↑ | LPIPS ↓ |
|---|---|---|---|---|
| Baseline 4 | ✓ | 20.83 | 0.89 | 0.12 |
| Baseline 4 | estimated | 14.46 | 0.79 | 0.20 |
| Present | x | 17.13 | 0.87 | 0.12 |

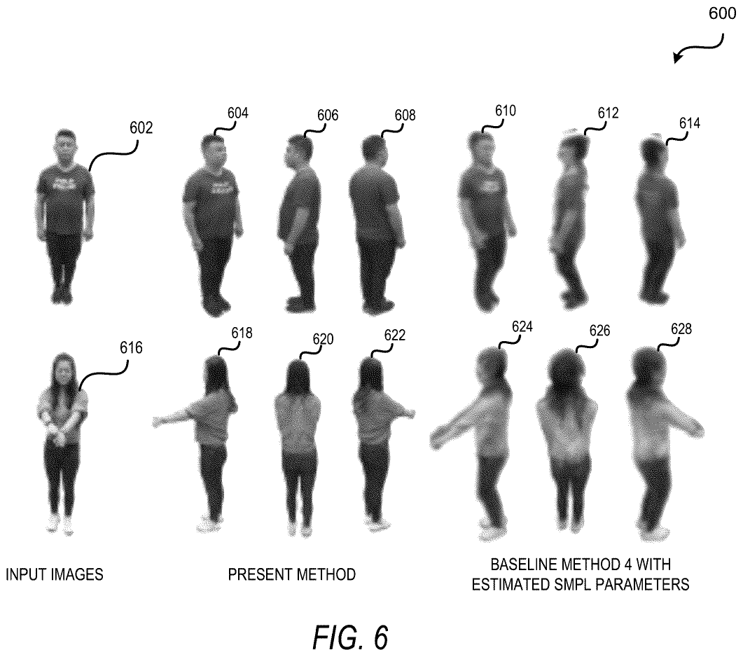

The robustness is also illustrated in FIG. 6. FIG. 6 depicts an example of a comparison 600 of rendered images in novel views using different reconstruction methods, according to certain embodiments of the present disclosure. In FIG. 6, two input images 602 and 616 are used separately for generating output images in novel views by the present method and baseline method 4 with estimated SMPL parameters. Since baseline method 4 with GT SMPL parameters is not a practical method with single-view input images, it is not used for image generation for purposes of image comparation in FIG. 6. From input image 602, a set of output images 604, 606, and 608 in different views are generated using the present method described herein, and a set of output images 610, 612, and 614 are generated using baseline method 4 with estimated SMPL parameters. Similarly using input image 616, a set of output images 618, 620, and 622 in different views are generated using the present method described herein, and a set of output images 624, 626, and 628 are generated using baseline method 4 with estimated SMPL parameters. By visual comparison, the surface quality of the novel view images generated by the present method is better than those generated by baseline method 4 with estimated SMPL parameters. For example, output images generated by the baseline method 4 with estimated SMPL parameters are blurrier (e.g., lower surface fidelity) than those generated by the present method. Especially, output images 612 and 614 include inconsistent pixel patches.

Table 3 shows full body reconstruction results on masked single-view images in terms of Chamfer distance, P2S, and Normal Consistency. As mentioned above, the lower values usually indicate better outcomes. The masks were randomly applied to each input image to simulate real-world occlusion scenarios. As shown in Table 3, Chamfer distance values, P2S values, and NC values corresponding to three baseline methods are much higher than those corresponding to the present 3D model reconstruction method. Thus, the full body reconstruction results by the baseline methods are not as good as those by the present 3D model reconstruction method.

TABLE 3
Full body reconstruction results on masked single-view images

| | | | Normal Consistency (NC)↓ | | | |
|---|---|---|---|---|---|---|
| Model | Chamfer | P2S | Front | Side | Back | Average |
| Baseline 1 | 9.86 | 10.54 | 0.401 | 0.352 | 0.250 | 0.339 |
| Baseline 2 | 10.12 | 10.75 | 0.381 | 0.351 | 0.231 | 0.328 |
| Baseline 3 | 11.26 | 11.74 | 0.409 | 0.355 | 0.243 | 0.341 |
| Present | 2.36 | 2.13 | 0.101 | 0.131 | 0.130 | 0.123 |

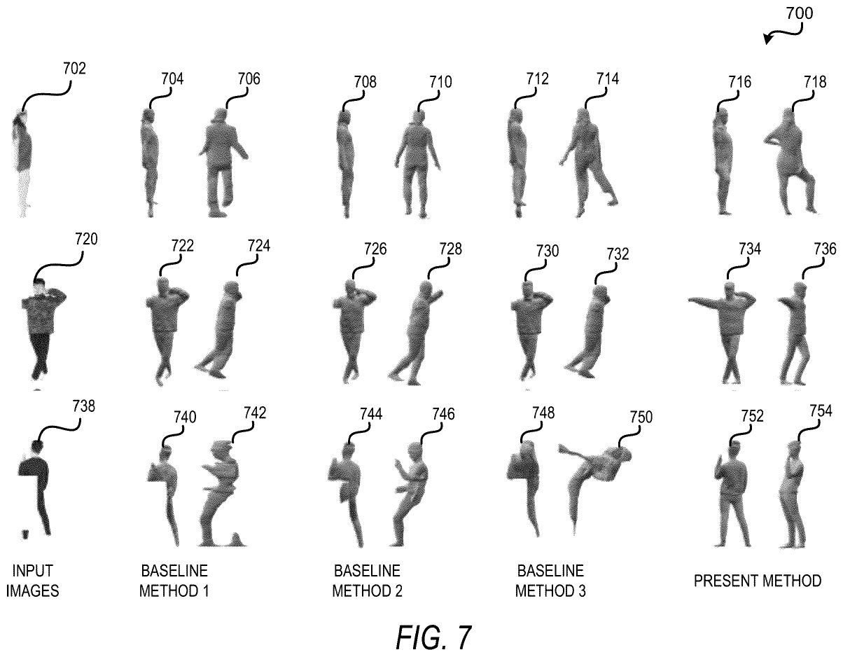

FIG. 7 depicts an example of a comparison 700 of images rendered using different 3D model reconstruction methods from input images with occlusions, according to certain embodiments of the present disclosure. As explained, the present 3D model reconstruction methods use a generative model (e.g., 3D diffusion model) to reconstruct complete human models from single-view images even when the humans in the single-view images are occluded. The generative model (e.g., a 3D diffusion model) used in the present 3D model reconstruction methods can sufficiently hallucinate the occluded part of the input image, and the metrics of the corresponding reconstructed full-body representation have acceptable values. As shown in FIG. 7, all three input images 702, 720, and 738 have occlusions. For example, the left arm of the person in input image 702 is occluded naturally by the body. Alternatively, a mask is applied to an input image to simulate occlusion before the input image is processed by baseline methods and the present 3D model reconstruction methods. For example, part of the right arm of the person in input image 720 and a portion of the person's body in input image 738 are, respectively, masked by an applied mask. The baseline methods and the present 3D model reconstruction methods reconstruct the human bodies depicted in the input images.

FIG. 7 shows a geometry in the same view as the input image and also a geometry in a different view. With input image 702, baseline method 1 generated a geometry 704 in the input view (e.g., side view) and a geometry 706 in the back view, baseline method 2 generates a geometry 708 in the input view and a geometry 710 in the back view, baseline method 3 generates a geometry 712 in the input view and a geometry 714 in the back view, and the present method generated a geometry 716 in the input view and a geometry 718 in the back view. The left arm, which is naturally occluded in input image 702, is not reconstructed properly by baseline method 1, as shown in geometry 706. With input image 720, baseline method 1 generated a geometry 722 in the input view (e.g., front view) and a geometry 724 in the side view, baseline method 2 generated a geometry 726 in the input view and a geometry 728 in the side view, baseline method 3 generated a geometry 730 in the input view and a geometry 732 in the side view, and the present method generated a geometry 734 in the input view and a geometry 736 in the side view. The right arm, which is partially masked in input image 720, is not reconstructed properly by any of the baseline methods, as shown in geometry 722, geometry 726, and geometry 730. With input image 738, baseline method 1 generated a geometry 740 in the input view (e.g., back view) and a geometry 742 in the side view, baseline method 2 generated a geometry 744 in the input view and a geometry 746 in the side view, baseline method 3 generated a geometry 748 in the input view and a geometry 750 in the side view, and the present method generated a geometry 752 in the input view and a geometry 754 in the side view. The masked part of the body in input image 738 is not reconstructed properly by any of the baseline methods, as shown in geometry 740, geometry 744, and geometry 748. The geometries in the side view (e.g., 742, 746, and 750) generated by the baseline methods are not realistic either. In contrast, the present method reconstructed the occluded part realistically and naturally.

Any suitable computing system or group of computing systems can be used for performing the operations described herein. For example, FIG. 8 depicts an example of the computing system 800 for implementing certain embodiments of the present disclosure. The implementation of computing system 800 could be used to implement the 3D model reconstruction application 102. In other embodiments, a single computing system 800 having devices similar to those depicted in FIG. 8 (e.g., a processor, a memory, etc.) combines the one or more operations depicted as separate systems in FIG. 1.

The depicted example of a computing system 800 includes a processor 802 communicatively coupled to one or more memory devices 804. The processor 802 executes computer-executable program code stored in a memory device 804, accesses information stored in the memory device 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

A memory device 804 includes any suitable non-transitory computer-readable medium for storing program code 805, program data 807, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 800 executes program code 805 that configures the processor 802 to perform one or more of the operations described herein. Examples of the program code 805 include, in various embodiments, the application executed by the 3D model reconstruction application 102, or other suitable applications that perform one or more operations described herein. The program code may be resident in the memory device 804 or any suitable computer-readable medium and may be executed by the processor 802 or any other suitable processor.

In some embodiments, one or more memory devices 804 stores program data 807 that includes one or more datasets and models described herein. Examples of these datasets include single-view feature representations (e.g., single-view feature triplanes), multi-view feature representations (e.g., multi-view feature triplanes), 3D representations, etc. In some embodiments, one or more of data sets, models, and functions are stored in the same memory device (e.g., one of the memory devices 804). In additional or alternative embodiments, one or more of the programs, data sets, models, and functions described herein are stored in different memory devices 804 accessible via a data network. One or more buses 806 are also included in the computing system 800. The buses 806 communicatively couples one or more components of a respective one of the computing system 800.

In some embodiments, the computing system 800 also includes a network interface device 810. The network interface device 810 includes any device or group of devices suitable for establishing a wired or wireless data connection to one or more data networks. Non-limiting examples of the network interface device 810 include an Ethernet network adapter, a modem, and/or the like. The computing system 800 is able to communicate with one or more other computing devices (e.g., client device 130) via a data network using the network interface device 810.

The computing system 800 may also include a number of external or internal devices, an input device 820, a presentation device 818, or other input or output devices. For example, the computing system 800 is shown with one or more input/output (“I/O”) interfaces 808. An I/O interface 808 can receive input from input devices or provide output to output devices. An input device 820 can include any device or group of devices suitable for receiving visual, auditory, or other suitable input that controls or affects the operations of the processor 802. Non-limiting examples of the input device 820 include a touchscreen, a mouse, a keyboard, a microphone, a separate mobile computing device, etc. A presentation device 818 can include any device or group of devices suitable for providing visual, auditory, or other suitable sensory output. Non-limiting examples of the presentation device 818 include a touchscreen, a monitor, a speaker, a separate mobile computing device, etc.

Although FIG. 8 depicts the input device 820 and the presentation device 818 as being local to the computing device that executes the 3D model reconstruction application 102, other implementations are possible. For instance, in some embodiments, one or more of the input device 820 and the presentation device 818 can include a remote client-computing device that communicates with the computing system 800 via the network interface device 810 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for case of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method performed by one or more processing devices, comprising:
receiving an input image of a target in a first view;
determining a single-view feature representation of the target using a trained single-view reconstruction model based on the input image;
generating a multi-view feature representation of the target using a pre-trained multi-view generative model based on the single-view feature representation;
determining a 3-dimensional (3D) representation of the target based on the multi-view feature representation using a neural volume rendering algorithm; and
generating one or more output images of the target in one or more views based on the 3D representation of the target.

2. The method of claim 1, wherein the target comprises a person, an animal, or a 3D object.

3. The method of claim 1, wherein the input image of the target comprises an occlusion of the target.

4. The method of claim 1, wherein the pre-trained multi-view generative model is a pre-trained 3D diffusion model comprising a U-Net.

5. The method of claim 1, wherein the trained single-view reconstruction model comprises an image encoder and an image decoder, wherein determining the single-view feature representation using the trained single-view reconstruction model based on the input image comprises:
encoding the input image to a set of patch-wise feature tokens using the image encoder; and
decoding the set of patch-wise feature tokens into the single-view feature representation using the image decoder.

6. The method of claim 1, wherein the neural volume rendering algorithm comprises a first multi-layer perceptron (MLP) module and a second MLP module, wherein determining a 3D representation of the target based on the multi-view feature representation using a neural volume rendering algorithm comprises:
predicting a set of signed distance function (SDF) values based on the multi-view feature representation using the first MLP module;
predicting a set of color values based on the multi-view feature representation using the second MLP module; and
determining the 3D representation of the target based on the set of SDF values and the set of color values.

7. The method of claim 1, further comprising:
training a multi-view reconstruction model using a first set of training images in different views for multiple training targets to obtain a trained multi-view reconstruction model; and
training a single-view reconstruction model using a second set of training images in single views for the multiple training targets to obtain the trained single-view reconstruction model, wherein the first set of training images in single views is a subset of the first set of training images in different views.

8. The method of claim 7, further comprising:
generating a multi-view feature triplane using the trained multi-view reconstruction model based on a subset of the first set of training images in different views for a training target;
generating a single-view feature triplane using the trained single-view reconstruction model based on a subset of the second set of training images in a single view for the training target;
adding a Gaussian noise to the multi-view feature triplane in multiple timesteps to obtain a noised multi-view feature triplane;
concatenating the single-view feature triplane as a conditioning to the noised multi-view feature triplane to form a training input; and
training a generative model using the training input and the noised multi-view feature triplane as training output to reproduce the multi-view feature triplane, thereby obtaining the pre-trained multi-view generative model.

9. The method of claim 8, further comprising:
applying a mask to a training image of the second set of training images to obtain a masked training image; and
generating the single-view feature triplane using the trained single-view reconstruction model based on a masked training image.

10. The method of claim 7, wherein the first set of training images in different views comprises training images in four different views for a corresponding target.

11. A system, comprising:
a memory component;
a processing device coupled to the memory component, the processing device to perform operations comprising:
receiving an input image of a target in a first view;
determining a single-view feature representation of the target using a trained single-view reconstruction model based on the input image;
generating a multi-view feature representation of the target using a pre-trained multi-view generative model based on the single-view feature representation; and
creating a 3-dimensional (3D) model of the target based on the multi-view feature representation using a neural volume rendering algorithm.

12. The system of claim 11, wherein the target comprises a person, an animal, or a 3D object, wherein the input image of the target comprises an occlusion of the target, and wherein the pre-trained multi-view generative model is a pre-trained 3D diffusion model comprising a U-Net.

13. The system of claim 11, wherein the trained single-view reconstruction model comprises an image encoder and an image decoder, wherein the processing device is to perform further operations comprising:
encoding the input image to a set of patch-wise feature tokens using the image encoder; and
decoding the set of patch-wise feature tokens into the single-view feature representation using the image decoder.

14. The system of claim 11, wherein the neural volume rendering algorithm comprises a first multi-layer perceptron (MLP) module and a second MLP module, wherein the processing device is to perform further operations comprising:
predicting a set of signed distance function (SDF) values based on the multi-view feature representation using the first MLP module;
predicting a set of color values based on the multi-view feature representation using the second MLP module; and
creating the 3D model of the target based on the set of SDF values and the set of color values.

15. The system of claim 11, wherein the processing device is to perform further operations comprising:
training a multi-view reconstruction model using a first set of training images in different views for multiple training targets to obtain a trained multi-view reconstruction model; and
training a single-view reconstruction model using a second set of training images in single views for the multiple training targets to obtain the trained single-view reconstruction model, wherein the first set of training images in single views is a subset of the first set of training images in different views.

16. The system of claim 15, wherein the processing device is to perform further operations comprising:
generating a multi-view feature triplane using the trained multi-view reconstruction model based on a subset of the first set of training images in different views for a training target;
generating a single-view feature triplane using the trained single-view reconstruction model based on a subset of the second set of training images in a single view for the training target;
adding a Gaussian noise to the multi-view feature triplane in multiple timesteps to obtain a noised multi-view feature triplane;
concatenating the single-view feature triplane as a conditioning to the noised multi-view feature triplane to form a training input; and
training a generative model using the training input and the noised multi-view feature triplane as training output to reproduce the multi-view feature triplane, thereby obtaining the pre-trained multi-view generative model.

17. A non-transitory computer-readable medium, storing executable instructions, which when executed by a processing device, cause the processing device to perform operations comprising:
receiving an input image of a target in a first view;
a step for determining a single-view feature representation of the target using a trained single-view reconstruction model based on the input image;
generating a multi-view feature representation of the target using a pre-trained multi-view generative model based on the single-view feature representation;
a step for determining a 3-dimensional (3D) representation of the target based on the multi-view feature representation using a neural volume rendering algorithm; and
generating one or more output images of the target in one or more views based on the 3D representation of the target.

18. The non-transitory computer-readable medium of claim 17, wherein the operations further comprise:
training a multi-view reconstruction model using a first set of training images in different views for multiple training targets to obtain a trained multi-view reconstruction model; and
training a single-view reconstruction model using a second set of training images in single views for the multiple training targets to obtain the trained single-view reconstruction model, wherein the first set of training images in single views is a subset of the first set of training images in different views.

19. The non-transitory computer-readable medium of claim 18, wherein the operations further comprise:
generating a multi-view feature triplane using the trained multi-view reconstruction model based on a subset of the first set of training images in different views for a training target;
generating a single-view feature triplane using the trained single-view reconstruction model based on a subset of the second set of training images in a single view for the training target;
adding a Gaussian noise to the multi-view feature triplane in multiple timesteps to obtain a noised multi-view feature triplane;
concatenating the single-view feature triplane as a conditioning to the noised multi-view feature triplane to form a training input; and
training a generative model using the training input and the noised multi-view feature triplane as training output to reproduce the multi-view feature triplane, thereby obtaining the pre-trained multi-view generative model.

20. The non-transitory computer-readable medium of claim 19, wherein the operations further comprise:
applying a mask to a training image of the second set of training images to obtain a masked training image; and
generating a single-view feature triplane using the trained single-view reconstruction model based on a masked training image.
